(19) United States
(12) Patent Application Publication
(10) Pub. No.: US 2008/0275617 A1
(43) Pub. Date: Nov. 6, 2008

(54) Method for Calculating the Low Pressure in the Servobrake of a Vehicle Comprising an Otto Engine

(75) Inventors: Oliver Kirmess, Riedstadt (DE); Oswald Helmut, Albig (DE); Uwe Steinmann, Darmstadt (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 11/994,922

(22) PCT Filed: Jul. 4, 2006
(86) PCT No.: PCT/EP2006/006483

§ 371 Date: Jul. 10, 2008

(30) Foreign Application Priority Data
Jul. 7, 2005 (DE) 10 2005 031 734.0

(51) Int. Cl. B60T 7/12; B60T 8/172; B60T 8/32; B60T 13/52; F02D 13/04

(52) U.S. Cl. 701/76

(57) ABSTRACT

The subject of the invention concerns at least a method for the determination, without a pressure sensor, of a pressure in a brake booster actuated with an actuator for a motor vehicle with engine system including an inlet pipe subjected to inlet pipe pressure, for optimized performance of a braking operation, including the steps of: detecting the driving situation and simulating the pressure (BP_SIM) as a function of the driving situation, and a device for boosting the brake pressure in an Otto engine-driven motor vehicle with an actuator and a vacuum-dependent pressure-boosting device coupled to the actuator, wherein the pressure-boosting device is designed without a vacuum sensor, and a brake booster, with means for carrying out the method.

### CROSS-REFERENCE TO RELATED APPLICATIONS

This application is a U.S. National-Stage entry under 35 U.S.C. § 371 based on International Application No. PCT/EP2006/006483, filed Jul. 4, 2006, which was published under PCT Article 21(2) and which claims priority to German Application No. DE 10 2005 031 734.0, filed Jul. 7, 2005.

### TECHNICAL FIELD

The present invention concerns a method for the determination, without a pressure sensor, of a pressure in a brake booster actuated with an actuator for a motor vehicle, for optimized performance of a braking operation, a device for boosting the brake pressure in a motor vehicle driven by a quantity-controlled Otto engine with an actuator and a vacuum-dependent pressure-boosting device coupled to the actuator, and with a brake booster.

### BACKGROUND

Methods and devices of this kind are used in nearly all Otto engine-driven motor vehicles.

For example, DE 197 53 450 A1 presents a method and a device for generating a vacuum in an engine. The engine includes an inlet path, combustion chambers and an exhaust path. An air flow in the inlet path is controlled by a throttle valve. An exhaust gas recirculation (EGR) passage diverts part of a flow of the exhaust gas from the exhaust path to the inlet path. An EGR valve regulates the flow of exhaust gas which flows through the EGR passage. A brake booster is connected to the inlet path and increases the brake pressure of the vehicle. A pressure sensor detects the pressure in the booster. A central processing unit (CPU) determines whether the detected pressure is higher than a predetermined value. The throttle valve is in a relatively wide open position when the engine performs stratified combustion. The throttle valve reduces the pressure in the inlet path when the throttle valve restricts the flow. The CPU controls the throttle valve in order to reduce the pressure in the inlet path when the booster pressure is higher than the predetermined value, and it actuates the EGR valve in order to reduce the gas flow in the EGR passage. This yields better brake and engine operation.

The method described there and the device described there have the drawback that a sensor for detecting the pressure in the vacuum chamber of the brake booster is necessary for optimizing control of the vacuum. This sensor can be a source of errors and, in case of failure of this sensor, it can be repaired or replaced only with some effort.

From EP 1 021 327 B1 is known a vehicle braking system of a motor vehicle, in which braking devices on its wheels can be subjected to pressure via a master brake cylinder, with an electronically controllable brake booster with a vacuum chamber and a pressure chamber which are separated from each other by a movable wall, a control valve assembly which can be actuated by means of an electromagnetic actuator, and by which a pressure difference can be set between the pressure and vacuum chambers, wherein the movable wall changes position and in the process actuates a master brake cylinder as a function of the pressure conditions in the vacuum chamber and the pressure chamber, wherein the electromagnetic actuator during operation is supplied by an electronic control unit with current signals which the electronic control unit generates as a function of dynamic states or external influences which are detected by sensors connected to the electric control unit, and, where certain dynamic states or external influences or combinations thereof which necessitate actuation of the master brake cylinder within a predetermined time interval with a predetermined probability are present, the electronic control unit generates current signals for the electromagnetic actuator, so that the control valve assembly is actuated to such an extent that play, free travel or tolerance-related lost motion existing at least in the brake booster are overcome, wherein there is no actuation of the braking device, the electronic control unit has a computer for linking the signals detected by the sensors according to predetermined rules, and a memory for storing the predetermined rules and empirical values obtained during operation of the vehicle braking system, and the empirical values stored in the memory are combinations of detected sensor signals and probability values with which braking was carried out in the past where the respective combination of detected sensor signals is present within a time interval.

The vehicle braking system mentioned above has the drawback that only the actuator is actuated via an electronic control unit, but not the brake pressure is controllable via predetermined rules, depending on the vehicle situation, so that there is no determination of the pressure in the braking chambers here.

It is therefore desirable to provide a method, a device for boosting the brake pressure and a brake booster, which determines the vacuum without the aid of a pressure sensor in the brake booster and, in the event that the respective driving situation so requires, provides the optimized vacuum in the brake booster.

### SUMMARY

The invention includes the technical instruction that, in a method for the determination, without a pressure sensor, of a pressure in a brake booster actuated with an actuator for a motor vehicle, for optimized performance of a braking operation there are included the steps of: detecting the driving situation and simulating the pressure as a function of the driving situation.

This solution affords the advantage that, for determination of the vacuum or in general the pressure in brake boosters, an elaborate pressure sensor together with associated wiring and any evaluating units in the engine control device are no longer needed for adaptation of the pressure to the respective driving situation.

Further, the invention includes the technical instruction that, in a device for boosting the brake pressure in a motor vehicle driven by a piston engine with an actuator and a vacuum-dependent pressure-boosting device coupled to the actuator, the pressure-boosting device is designed without a vacuum sensor in order to design a pressure-boosting device without a pressure sensor as a function of the vacuum.

Also, the invention includes the technical instruction that, in a brake booster are provided means for carrying out the method according to the invention.

By determining the pressure in the brake booster without a pressure sensor, the susceptibility to errors when calculating the pressure is greatly reduced on account of the independence of sensors and any other evaluating units.

It is preferred that detection of the driving situation model includes the steps of: ascertaining the initial value of the pressure, detecting and storing variable driving situation parameters, and defining fixed driving situation parameters.

Due to these steps, the model which serves as the basis for calculating the pressure can be adapted to constantly changing situations and/or extended and also designed as an automatically applicable system.

It is further preferred that simulation of the pressure includes the steps of: initializing the pressure, checking and signaling whether an actuator is actuated, calculating the pressure as a function of the driving situation parameters and actuation of the actuator, fixing the pressure as a function of the calculation made.

Thus, depending on the driving situation, a corresponding pressure can be provided, so that optimum brake boosting can always be achieved.

Preferably, the driving situation parameters are selected from the group including: inlet pipe pressure, brake light switch signal, brake switch signal, vehicle speed, ambient pressure, vehicle acceleration, torque, engine speed and gear.

Also it is preferred that, upon actuation of the actuator and hence indirectly the brake and/or brake light switch, the vehicle speed is monitored and at least one variable driving situation parameter is calculated for the optimized braking operation.

In particular, the variable driving situation parameter can be the deceleration.

It is preferred that, when the brake switch is actuated, the pressure is increased as a function of the deceleration.

A fixed driving situation parameter can be the value for deceleration in case of hard braking, which is predetermined.

Also it is preferred that, when the vehicle speed falls below a limit value, upon activation of the actuator a reduction of brake vacuum or a pressure increase, which corresponds to hard braking, is simulated.

Also it is preferred that, when the pressure in the brake booster is greater than an inlet pressure in the engine, the pressure is reduced to the inlet pipe pressure level.

Further it is preferred that, in a method for operating a braking system for a motor vehicle with a brake booster without a pressure sensor for calculating the pressure in the brake booster, there is included a method according to the above for performing an optimized braking operation.

A device for boosting the brake pressure in an Otto engine-driven motor vehicle with an actuator and a vacuum-dependent pressure-boosting device coupled to the actuator is also preferred, wherein the pressure-boosting device is designed without a vacuum sensor.

In this way a less elaborate pressure-boosting device can be produced with parts less susceptible to breakdown.

In particular, it is preferred that the pressure-boosting system is designed as a brake booster with means for carrying out the method according to the invention. The method can, for example, be realized as a circuit or as a computer program product.

To carry out the method, altogether different input variables are needed. The model for carrying out the method thus needs, for example, five input variables. These are selected from among the group including pressure in the inlet pipe, brake light actuation bit, brake bit, vehicle speed and air pressure of the environment.

As the output variable, the model delivers the simulated pressure in the brake booster.

In order that the method is flexibly adaptable to different situations, the model uses various calibrating variables. These are selected from among the group including: volume factor of brake booster (hereinafter K₁), limit for speed dependence (hereinafter K₂), minimum simulated brake pressure increase in the event that the brake light actuation bit is activated (hereinafter K₃), minimum simulated brake pressure increase when the brake bit is activated (hereinafter K₄), vehicle deceleration factor in case of hard braking (hereinafter K₅), leveling factor of pressure equalization of simulated brake pressure as a function of the pressure in the inlet pipe (hereinafter K₆).

The method starts with initialization, that is, the simulated brake pressure is set to an initial value. The simulation takes place in real time, that is, the time steps of simulation are identical with the time steps of measurements used. Basically, the simulated brake pressure remains constantly at the initial value until one of the following cases occurs:

1. the pressure in the inlet pipe becomes lower than the simulated brake pressure, that is, to be more precise, the inlet pipe pressure drops below the pressure in the brake booster, or

2. the bit for brake light or brake changes from 1 to 0, which means that the brake pedal is released.

In these cases, the simulated brake pressure changes as follows, as a function of the cases:

In the first case the simulated brake pressure decreases by sliding averaging uniformly according to the following formula:

BPᵢ₊₁=BPᵢ−K₆·(BPᵢ−MAPᵢ), where BP stands for the simulated brake pressure, K₆ for the above-mentioned calibrating factor, and MAP for the pressure in the inlet pipe. K₆ here is within the range 0 to 1. In calculation of the simulated brake pressure, the inertia is thus noted in pressure equalization. If K₆ is zero, then no pressure equalization takes place; if K₆ is 1, then direct pressure equalization takes place.

In the second case, in addition it is distinguished whether the vehicle speed exceeds a critical speed. The critical speed is here taken into consideration via the above-mentioned calibrating factor K₂.

Therefore in the event that the vehicle speed is below the critical speed, for example, while stationary or at walking speed, in the event that the brake light bit was 1 during the braking operation the simulated brake pressure is increased, assuming hard braking, according to the following formula:

BPᵢ₊₁=BP+K₁·(AMP−BPᵢ), where K₁ is basically calculated according to the following formula:

$${K}_{1} = \frac{{V}_{work . max}}{{V}_{tot}} ,$$

where V_{work.max} corresponds to the volume of the work chamber in the brake booster during hard braking, and Vₜₒₜ corresponds to the total volume of the brake booster. K₁ thus denotes the calibrating variable of volume factor of brake booster. AMP here corresponds to the air pressure of the environment.

In the event that the brake bit was 0 during the braking operation, the simulated brake pressure is increased, assuming very soft braking, this being according to the following formula:

BPᵢ₊₁=BPᵢ+K₁·K₃·(AMP−BPᵢ), where K₃ corresponds to the above-mentioned calibrating variable of minimum simulated brake pressure increase if only brake light bit is activated. K₃ is within the range between 0 and 1 and can, for example, assume a value of 0.2.

In the event that the vehicle speed has a value which is equal to or above the calibrating factor of limit for speed dependence, then the simulated brake pressure is increased during the braking operation according to the calculated maximum deceleration of the vehicle, this being as follows:

$$B {P}_{i + 1} = B {P}_{i} + {K}_{1} \cdot α \cdot ( A M P - B {P}_{i} ) , where α = min ( \frac{\begin{matrix}max & ( {VS}_{x - 0.05} - {VS}_{x} \\ braking & \end{matrix}}{{K}_{5}} ) , {K}_{3} .$$

Here, (VSₓ−0.05−VSₓ) denotes the speed difference between two scans at an interval of 0.05 second, and K₅ denotes this difference during hard braking, and so corresponds to the calibrating variable of vehicle deceleration during hard braking. K₃ (above-mentioned calibrating variable) corresponds to the minimum value of α, which is set at least when the brake bit is 0 during the braking operation. In the event that the brake bit is 1, instead of K₃ the calibrating variable K₄ (minimum simulated brake pressure increase when brake bit is activated) is used as the minimum value, where K₄ can be >=0 and <=1, for example, 0.3. In this case the above formula changes as follows:

$$α = min ( \frac{\begin{matrix}max & ( {VS}_{x - 0.05} - {VS}_{x} \\ braking & \end{matrix}}{{K}_{5}} ) , {K}_{4} .$$

Here, the vehicle speed is always considered at the start of the braking operation, that is, when the brake light bit or the brake bit changes from 0 to 1.

### BRIEF DESCRIPTION OF THE DRAWINGS

The present invention will hereinafter be described in conjunction with the following drawing figures, wherein like numerals denote like elements, and

FIG. 1 illustrates a schematic drawing of the method for calculating the pressure in a brake booster with several submodels;

FIG. 2 illustrates a schematic drawing of a first submodel (maximum deceleration);

FIG. 3 illustrates a schematic drawing of a second submodel (brake pressure equalization); and

FIG. 4 illustrates a schematic drawing for a third submodel (braking detector).

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

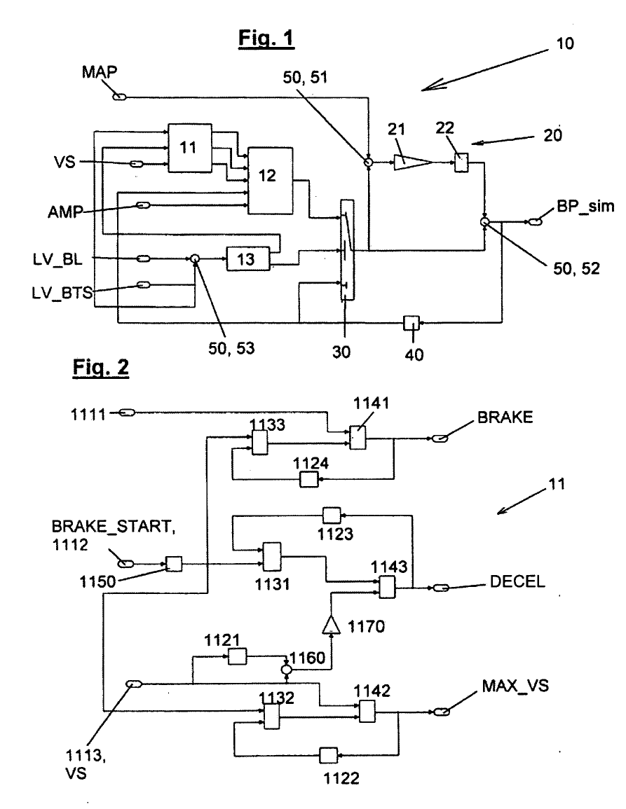

FIG. 1 shows a model 10 or a schematic drawing of the method for calculating a pressure in a brake booster without a pressure sensor. The model 10 includes several submodels, three submodels being shown here—first submodel 11 for maximum deceleration, second submodel 12 for brake pressure equalization and third submodel 13 as a braking detector. Further, the model 10 includes an averager 20 which in turn has an amplifier 21 and a saturation component 22. Also the model 10 includes a switch 30 and a holding component 40 and various calculating components 50, the calculating components including a first adder 51, a second adder 52 and a third adder 53.

The model 10 receives several, here five, model input signals. A first model input signal MAP indicates the pressure in the inlet pipe—the inlet pipe pressure—in hPa. A second model input signal LV_BLS—brake light bit—indicates in binary form whether a brake light is switched on or off, the value 1 standing for “on”. A third model input signal LV_BTS—brake bit—indicates in binary form whether a brake is actuated or unactuated, the value 1 standing for “brake actuated”. A fifth model input signal VS—vehicle speed—indicates the vehicle speed in km/h. A fifth model input signal AMP—air pressure of environment—indicates the air pressure of the environment in hPa.

As the model output signal BP_sim—simulated pressure in the brake booster—the model 10 delivers the simulated brake pressure in the brake booster in hPa.

The first input signal MAP goes direct to the second adder 52.

The second input signal LV_BLS goes direct to the third adder 53.

The third input signal LV_BTS goes both to the third adder 53 and to the first submodel 11.

The third adder 53 delivers, as the third-adder-output signal BTS_plus_BLS, the sum of the first input variable and the second input variable.

The fourth input signal VS goes direct to the first submodel 11.

The fifth input signal AMP goes direct to the second submodel 12.

For greater clarity, first the submodels 11, 12, 13 described in FIG. 2 to FIG. 4 are described before the model 10 is described further. Here, first of all for reasons of clarity the third submodel 13 which is shown in FIG. 4 is described.

FIG. 4 shows the third submodel 13 which models a braking detector. As the input signal, the third submodel 13 has the third-adder-output signal BTS_plus_BLS.

The third submodel 13 includes several third-submodel-detector components 1310, four third-submodel-detector components 1311, 1321, 1331, 1341 being included here.

Further, the third submodel 13 has several third-submodel-integrator components 1320, two third-submodel-integrator components 1321, 1322 being included here.

The input signal of the third submodel 13 BTS_plus_BLS is branched and goes to a first and a second third-submodel-detector component 1311 and 1313.

In the first third-submodel-detector component 1311, it is ascertained whether the input signal is increasing.

In the second third-submodel-detector component 1313, it is ascertained whether the input signal is falling.

If an increase of the signal is ascertained in the first third-submodel-detector component 1311, the signal is branched and goes to the first and second third-submodel-integrator components 1321, 1322.

If a decrease of the signal is ascertained in the second third-submodel-detector component 1312, the signal is branched and likewise goes to the first and second third-submodel-integrator components 1321, 1322.

The third-submodel-integrator components 1321 and 1322 add up the signals and in each case output a further signal which accordingly goes to a third and fourth third-submodel-detector component 1312 and 1314 respectively. There, analogously to the first and second third-submodel-detector components 1311 and 1313, an increase or decrease of the signal is ascertained and accordingly the third-submodel-output signals BRAKE_START and BRAKE_STOP are set. BRAKE_START is 1 precisely when the third-submodel-input signal BTS_plus_BLS increases (i.e. the brake bit or the brake light bit goes from 0 to 1), otherwise BRAKE_START or BRAKE_STOP is 1 precisely when BTS_plus_BLS drops (i.e. the brake bit or the brake light bit goes from 1 to 0), otherwise BRAKE_STOP or BRAKE_START therefore signals the start of a braking operation, BRAKE_STOP the end of a braking operation.

This third-submodel-output signal BRAKE_START now goes firstly to the switch 30 and secondly to the first submodel 11 as the second first-submodel-input signal BRAKE_START. The first submodel is shown in FIG. 2.

FIG. 2 shows the first submodel 11. The first submodel 11 has three first-submodel-input signals: first first-submodel-input signal 1111, second first-submodel-input signal 1112 and third first-submodel-input signal 1113.

The first first-submodel-input signal 1111 is the third input signal LV_BTS.

The second first-submodel-input signal 1112 is the third-submodel-output signal BRAKE_START.

The third first-submodel-input signal 1113 is the fourth input signal VS.

Further, the first submodel 11 has three output variables: the first first-submodel-output variable BRAKE, the second first-submodel-output variable DECEL and the third first-submodel-output variable MAX_VS.

Also the first submodel 11 includes first-submodel-holding components 1120, first-submodel-product components 1130, first-submodel-maximum components 1140, first-submodel-negation component 1150 and first-submodel-adding components 1160 or, in the case of the last one, simply adder.

The first submodel 11 includes, to be more precise, four first-submodel-holding components 1121, 1122, 1123, 1124, three first-submodel-product components 1131, 1132, 1133, three first-submodel-maximum components 1141, 1142, 1143, one first-submodel-negation component 1150, one first-submodel-adder 1160 and one first-submodel-amplifier 1170.

The first first-submodel-input signal 1111 goes to a first first-submodel-maximum component 1141.

The second first-submodel-input signal 1112, which is designed as a trigger signal, and is made equal to 1 only when the brake or the brake light are activated, goes to the first-submodel-negation component 1150 and is there inverted in binary form, that is, made equal to 0 when the second first-submodel-input signal 1112 was 1 and vice versa.

Thus the three first-submodel-output variables BRAKE, DECEL, MAX_VS are reset to 0 at the start of braking. The negated second first-submodel-input signal proceeds to a first, second and third first-submodel-product component 1131, 1132, 1133.

The third first-submodel-input variable 1113 or VS is branched and goes to a first first-submodel-holding component 1121, a first first-submodel-adder 1160 and a second first-submodel-maximum component 1142.

Likewise the input variable 1112 negated and multiplied in the third product component goes to the second maximum component 1142.

The output signal of the second maximum component 1142 is fed back and goes via the second holding component 1122 to the second product component 1132.

The second maximum component 1142 delivers as the third first-submodel-output signal MAX_VS the maximum speed during the current braking operation.

From the holding component 1121, where the input variable or the input signal VS is held for about 0.05 seconds (according to the scan rate) and only then passed on, the input variable VS likewise goes to the adder 1160. The adder 1160 passes on the sum to the amplifier 1170. From there the amplified signal goes to the third maximum component 1143.

The second input signal 1112 negated and generated in the first product component 1131 goes to the third maximum component 1143.

The value which the third maximum component 1143 delivers is the second output signal DECEL and indicates the deceleration.

This output signal DECEL is fed back via the third holding component 1123 with the first product component 1131.

Upon comparison of the current deceleration with the previous deceleration, the higher value is always passed on. This is between 0 and 1, 0 denoting no deceleration and 1 denoting hard braking. DECEL therefore constitutes the maximum deceleration during the current braking operation.

The negated second input signal 1112 proceeds to the third product component 1133. The latter passes on a signal to the first maximum component 1141, where it is compared with the first input signal 1111. As a result, the second output variable BRAKE is generated. The second output variable is in this case 1 when the brake switch has been active since the last start of braking. This second output variable BRAKE is fed back via a fourth holding component 1124 with the third product component 1133.

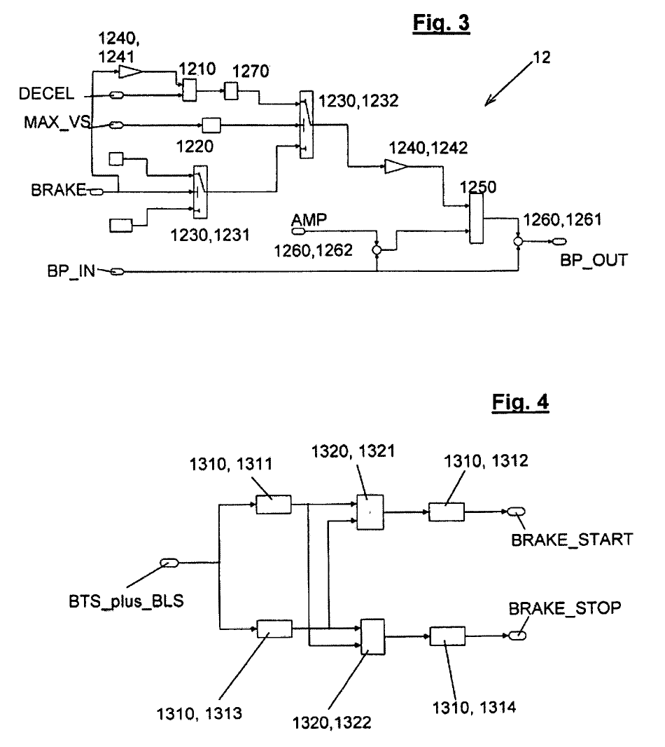

The three output signals BRAKE, DECEL, MAX_VS of the first submodel 11 go to the second submodel 12. Also the fifth input signal AMP and the fed-back output signal BP_SIM go to the second submodel 12. The second submodel 12 is shown in FIG. 3.

FIG. 3 shows the second submodel 12. The second submodel 12 has four second-submodel-input variables, first input variable DECEL, second input variable BRAKE, third input variable MAX_VS and fourth input variable BP_IN.

Further, the second submodel 12 has a maximum component 1210, a calculating component 1220, two switches 1230, two amplifiers 1240, a product component 1250, two adders 1260 and a saturation component 1270.

The first input variable DECEL goes to the maximum component 1210.

The second input variable BRAKE is branched and goes via a first amplifier 1241 with the gain K₄ (above-mentioned calibrating variable) likewise to the maximum component 1210 and to a first switch 1231.

The first maximum component 1211 generates a signal which goes to the saturation component 1270. The lower limit of the saturation component is determined by the calibrating variable K₃. 1270 generates a saturation component output signal which is passed on to the second switch 1232. The switched switch output signal passes to a second amplifier 1242 and from there to the product member 1250. From there it passes to a first adder 1261 which as the output variable delivers the second-submodel-output signal BP_OUT.

The third output signal MAX_VS goes to the calculating component 1220. This calculating component 1220 compares the third input signal MAX_VS with a predetermined value and delivers a first-calculating-component-output signal which is passed on to the second switch 1232.

The fourth input signal BP_IN is branched and goes one time to the first adder 1261 and another time to the second adder 1262.

In the second adder 1262 it is added to the fifth input signal AMP and goes to the product component 1250.

The product component 1250 delivers a signal to the first adder 1261, which is added to the fourth input signal BP_IN and so delivers the second-submodel-output signal BP_OUT.

In FIG. 1 BP_OUT, BRAKE_STOP and BP_SIM are now applied to the switch. The signal BP switched by the switch is branched and goes to two adders where on the one hand it is added to the first input variable, amplified and saturated, and then goes to the second adder where it is added to the signal BP. The result constitutes the simulated pressure BP_SIM. This value is fed back.

The method for simulation of the pressure in the brake booster can, using additional input variables, be extended by gradient detection. Then, in addition to the input variables indicated on page 7, line 15 ff., the vehicle acceleration, torque, engine speed and gear are needed. With gradient detection, simulation of the pressure BP_SIM is improved for driving on a non-level road, as the deceleration DECEL also depends on the gradient of the road.

The gradient is determined according to the following principle:

The power delivered by the engine is calculated from torque and engine speed, and the power which is consumed for road resistance on a level road is calculated from vehicle speed and gear. From these is determined the nominal acceleration of the vehicle on a level road. From the difference between the nominal acceleration and the actual vehicle acceleration is concluded the gradient, which is then included in the calculation of the second first-submodel-output variable DECEL.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

### LIST OF REFERENCE NUMBERS

10 model
11 first submodel
12 second submodel
13 third submodel
20 averager
21 amplifier
22 saturation component
30 switch
40 holding component
50 calculating components
51 first adder
52 second adder
53 third adder
MAP first model input variable
LB_BLS second model input variable
LV_BTS third model input variable
VS fourth model input variable
AMP fifth model input variable
BP_sim model output variable
BTS_plus_BLS third-adder-output signal
1310 third-submodel-detector components
1311 first third-submodel-detector component
1312 second third-submodel-detector component
1313 third third-submodel-detector component
1314 fourth third-submodel-detector component
1320 third-submodel-integrator components
1321 first third-submodel-integrator component
1322 second third-submodel-integrator component
BRAKE_START first third-submodel-output signal
BRAKE_STOP second third-submodel-output signal
1111 first first-submodel-input signal
1112 second first-submodel-input signal
1113 third first-submodel-input signal
BRAKE first first-submodel-output variable
DECEL second first-submodel-output variable
MAX_VS third first-submodel-output variable
1120 first-submodel-holding components
1121 first first-submodel-holding component
1122 second first-submodel-holding component
1123 third first-submodel-holding component
1124 fourth first-submodel-holding component
1130 first-submodel-product components
1131 first first-submodel-product component
1132 second first-submodel-product component
1133 third first-submodel-product component
1140 first-submodel-maximum components
1141 first first-submodel-maximum component
1142 second first-submodel-maximum component
1143 third first-submodel-maximum component
1150 first-submodel-negation component
1160 first-submodel-adder
1170 first-submodel-amplifier
BP_IN fourth second-submodel-input variable
1210 second-submodel-maximum components
1220 second-submodel-calculating components
1221 first second-submodel-calculating component
1222 second second-submodel-calculating component
1223 third second-submodel-calculating component
1230 second-submodel-switches
1231 first second-submodel-switch
1242 second second-submodel-switch
1240 second-submodel-amplifiers
1241 first second-submodel-amplifier
1242 second second-submodel-amplifier
1250 second-submodel-product component
1260 second-submodel-adders
1261 first second-submodel-adder
1262 second second-submodel-adder
1270 second-submodel-saturation component
BP_OUT second second-submodel-output signal
K_1 first calibrating variable
K_2 second calibrating variable
K_3 third calibrating variable
K_4 fourth calibrating variable
K_5 fifth calibrating variable
K_6 sixth calibrating variable

### Translator's Key to Drawings:

VERZ=DECEL

1. Method for the determination, without a pressure sensor, of a pressure in a brake booster actuated with an actuator for a motor vehicle with engine system including an inlet pipe subjected to inlet pipe pressure, for optimized performance of a braking operation, comprising the steps of:
detecting the driving situation; and
simulating the pressure (BP_SIM) as a function of the driving situation.

2. Method according to claim 1, wherein detection of the driving situation comprises the steps of:
ascertaining the initial value of the pressure (BP_SIM);
detecting and storing variable driving situation parameters; and
defining fixed driving situation parameters.

3. Method according to claim 1, wherein simulation of the pressure (BP_SIM) comprising the steps of:
initializing the pressure (BP_SIM);
checking and signal whether an actuator is actuated;
calculating the pressure (BP_SIM) as a function of the driving situation parameters and actuation of the actuator (LV_BLS, LV_BTS); and
fixing the pressure (BP_SIM) as a function of the calculation made.

4. Method according to claim 1, wherein the driving situation parameters are selected from the group consisting of:
an inlet pipe pressure (MAP), a brake light switch signal (LV_BLS), a brake switch signal (LV_BTS), a vehicle speed (VS), an ambient pressure (AMP), a vehicle acceleration (ACC), a torque (TQ), an engine speed (N), or a gear (GEAR).

5. Method according to claim 1, wherein, upon actuation of the actuator and hence indirectly the brake and/or brake light switch, the vehicle speed is monitored and at least one variable driving situation parameter is calculated for the optimized braking operation.

6. Method according to claim 5, wherein the variable driving situation parameter is the deceleration.

7. Method according to claim 6, wherein, when the brake switch is actuated, the pressure (BP_SIM) is increased as a function of the deceleration.

8. Method according to claim 3, wherein a fixed driving situation parameter is the value for deceleration in case of hard braking and is predetermined.

9. Method according to claim 3, wherein, when the vehicle speed falls below a limit value, upon activation of the actuator a pressure increase corresponding to hard braking is simulated.

10. Method according to claim 9, wherein, when the pressure (BP_SIM) in the brake booster is greater than the inlet pipe pressure in the inlet pipe, the pressure (BP_SIM) is reduced to the inlet pipe pressure level.

11-13. (canceled)
